(19) United States
(12) Patent Application Publication
(10) Pub. No.: US 2025/0173796 A1
(43) Pub. Date: May 29, 2025

(54) Method for Setting a Dynamic Car-Insurance Premium

(71) Applicant: Vincent Loccisano

(72) Inventor: Vincent Loccisano

(21) Appl. No.: 18/521,572

(22) Filed: Nov. 28, 2023

(51) Int. Cl. G06Q 40/08

(52) U.S. Cl. CPC G06Q 40/08

(57) ABSTRACT

A method for dynamically generating temporal auto-insurance premium prices for operators of human-controlled vehicles in the realm of driverless vehicles, and offering it through an insurance exchange. In one embodiment, a dynamic insurance premium considers a risk score based on criteria specific to a vehicle operator and refines the risk score according to criteria specific to the insured vehicle. The risk score is further refined according to the vehicle's environment. A final risk score is determined, and a dynamic premium is set. In this example, a dynamic premium is an insurance premium set for the duration of one use of a vehicle.

### TECHNICAL FIELD

The present disclosure relates generally to a computerized method for a commercial insurer to maintain and manipulate data relevant to the cost of insurance, and more specifically to duration-based, dynamic pricing of automotive insurance for human-operated vehicles with or without automatic safety features.

### BACKGROUND OF THE INVENTION

Auto-operated vehicles use a system of sensors that detect its location and surroundings. An auto-operated vehicle processes that sensor data by the use of onboard software to control the speed, braking and steering of the auto-operated vehicle. Auto-operated vehicles actively and passively communicate with their environment—responding to traffic signals, gauging proximity to other objects, etc.—as well as with other automated vehicles. Other vehicles may be auto-operated, human-operated, or a combination of those, as with human-operated vehicles that have automated features.

Vehicle insurance exists to provide financial protection against physical damage and bodily injury resulting from accidents, and against liability that may arise when other individuals are involved in an accident. Commonly, an insurance policy has a policy rate, or premium, that extends for a specified term. In exchange for the premium, the insurer pays for covered damages as specified in the insurance policy. An insurance policy is in force as long as premium payments are made, and usually expire after one year.

Premiums are determined according to a selected level of insurance coverage, as well as the location of the vehicle, the vehicle model, and characteristic demographics of the driver. Driver characteristics affecting a premium might be age, number of years operating a vehicle, and prior incidents or claims. Telematics is an interdisciplinary field encompassing telecommunications and information processing for the purpose of vehicle tracking and vehicle safety. Safety related communications include vehicle speed, traffic density, weather, and the like.

Current premium-determination methods do not account for characteristics of operators interacting with auto-operated vehicles or vehicles with automated safety features, nor do they adjust insurance premiums according to such characteristics. Furthermore, traditional premium-determination methods do not offer dynamic pricing based on current driving conditions.

### SUMMARY OF THE INVENTION

The present disclosure relates to a method for dynamically generating temporal auto-insurance premium prices for operators of human-controlled vehicles in the realm of driverless vehicles, and offering it through an insurance exchange. Human-controlled vehicles are defined here as wholly human-operated vehicles, or vehicles with active or passive driver aids such as auto-braking and collision-avoidance systems.

In one embodiment, a dynamic insurance premium is determined by weighing a risk score based on criteria specific to a vehicle operator, and refines the risk score according to criteria specific to the insured vehicle. The risk score is further refined according to the vehicle's environment. A final risk score is determined, and a dynamic premium is set. In this example, a dynamic premium is an insurance premium set for the duration of one use of a vehicle.

Operator-specific criteria may include age, safety record and driving habits of an operator. Driving habits may include frequency and time of day that the operator usually operates the insured vehicle; operator-safety record; and similar factors. One skilled in the art understands that an operator who commonly drives a vehicle multiple times daily would have a higher risk score than someone who drives the insured vehicle less frequently.

Vehicle-specific criteria may include the age of the vehicle; the value of the vehicle; and vehicle-safety features such as automated braking, collision-avoidance, auto-operated features and other features.

Environmental criteria may include the density of traffic in the vehicle's environment; density of traffic along a proposed route; quantity of auto-operated vehicles in immediate proximity, as well as along a proposed route, as well as likely density on particular days or times of day.

One skilled in the art understands that a dynamic insurance premium may be calculated instantaneously for a vehicle and only for the period of time and distance driven and the surrounding conditions. A dynamic insurance premium may be calculated on a recurring basis. In some embodiments the recurring basis is time driven wherein a dynamic insurance premium is recalculated at predetermined timed intervals. In other embodiments a recurring basis is environment driven wherein changes in the location of the driver and vehicle may involve a change in traffic density, number of self-driven vehicles and the like. In yet other embodiments the recurring basis is driven by any change in the insured's risk score.

In an example embodiment, an entirely manually operated vehicle that is seldom driven, and during only non-peak driving times, would generally receive a lower insurance premium for a given duration. Another vehicle, one that is equipped with automated safety features and driven during peak hours, would be assigned a higher insurance premium for a given duration. A vehicle with automated safety features, driven in a densely populated area, surrounded by auto-operating vehicles or vehicles with automated safety features, may be given a lower premium for a duration than one for a vehicle that is entirely manually operated, in a sparsely populated area surrounded by predominantly manually operated vehicles.

Some auto insurances use telematics, a data-monitoring system that uses in-car tracking devices to monitor one's driving habits. Telematics enables an insurance company to develop and report sets of real-time conditions such as operator location; common traffic density at a given time; current traffic density; weather conditions; and the number of auto-operated vehicles in surrounding traffic. In a proposed method, sensors may be embedded in an insured vehicle or operated from a smartphone app, using telematics to set a dynamic insurance premium.

In some embodiments of a method, a dynamic insurance premium considers a set of real-time conditions and adjusts an insurance premium accordingly during the interval between insurance premium payments.

In other embodiments of a method, a dynamic insurance premium considers a set of real-time conditions and charges a premium for only the duration of use of the vehicle. Such real-time conditions may include traffic density, time of day, an operator's common driving habits, and the operator's operating characteristics. Operating characteristics may include an operators speed in comparison to a posted speed limit, acceleration, braking distance, steering and cognitive factors. One skilled in the art understands that steering may be measured with common sensors and may be calculated as to speed of change and the like. One skilled in the art understands that operator cognitive factors may be measured by tracking eye movement with common sensors to determine the operators time with eyes facing the road and time with eyes facing within the vehicle.

### BRIEF DESCRIPTION OF DRAWINGS

FIG. 1 is a diagram of a method of the disclosure.

FIG. 2 is a diagram of an iteration of a method of the disclosure.

### DETAILED DESCRIPTION

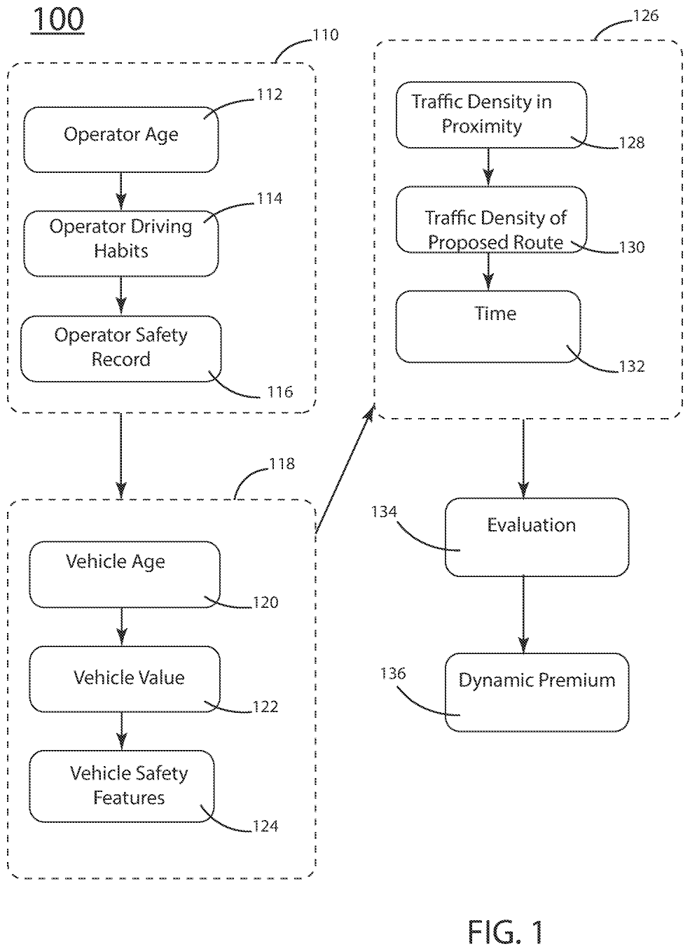

FIG. 1 shows an example embodiment in which a dynamic insurance premium is assigned to a vehicle. The protocol 100 sets a risk score 110 based on operator criteria including operator age 112, operator driving habits 114 and operator safety record 116. The risk score is refined by the evaluation of vehicle specific criteria 118, including vehicle age 120, vehicle value, 122 and vehicle safety features 124. The risk score is further refined by the evaluation of the relative environment 126 including traffic density 128, traffic density along a proposed route 130 and time of day 132. One skilled in the art understands that time of day may be used to evaluate the likely density of traffic during that time, or visibility during that time, or the like. Refined criteria 110, 118, 126 are combined in an evaluation 134 to generate a dynamic premium 134. One skilled in the art understands that the dynamic premium 136 may be applied for the duration of any given use of a vehicle, or may be continuously calculated over a time-averaged use of the vehicle.

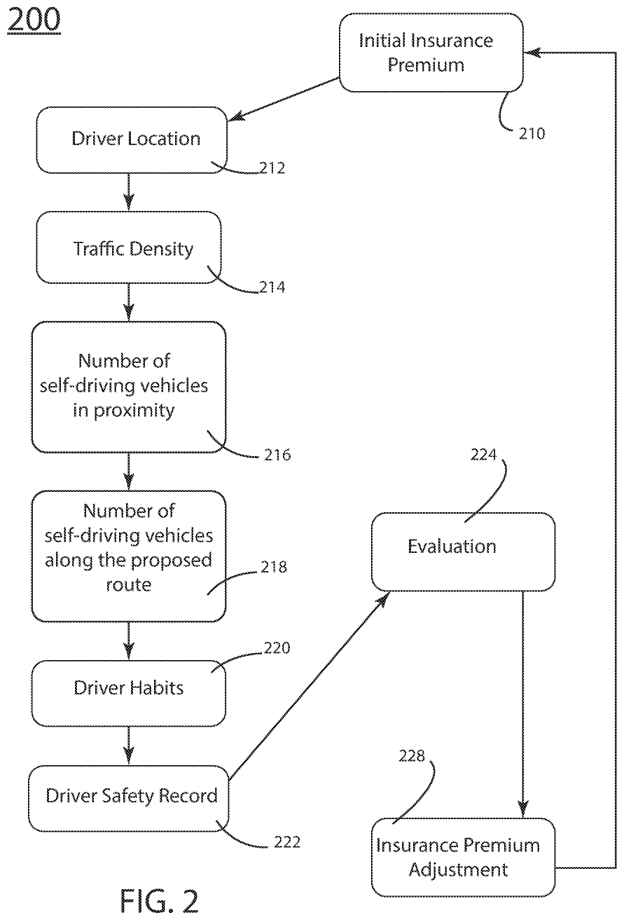

In a diagram of another example method, FIG. 2 shows a protocol 200 that considers an initial insurance premium 210; driver location 212; traffic density 214; number of auto-operating vehicles in proximity of the driver 216; number of auto-operating vehicles along the driver's proposed route 218; driver's habits 220; and drive-safety record 222. It evaluates those criteria 224 and calculates an adjusted insurance premium 228.

1. A method for operating an insurance exchange having dynamic, temporal premium-pricing, the method comprising:
establishing an insurance risk score based on criteria specific to a vehicle operator; and
refining said insurance risk score based on criteria specific to at least one of said operator's vehicle or vehicle operating environment; and
setting a price for a dynamic temporal insurance premium; wherein
said dynamic, temporal insurance premium is charged to the driver instantaneously for the use of the vehicle.

2. The method of claim 1 wherein:
said dynamic, temporal premium-pricing is charged for the duration of use of the vehicle.

3. The method of claim 1 further comprising:
said criteria specific to a vehicle operator includes:
evaluating said operator's age; and
evaluating said operator's safety record; and
evaluating said operator's common driving habits.

4. The method of claim 3 wherein:
said operator's common driving habits include:
said operator's habitual time of use.

5. The method of claim 3 wherein:
said operator's common driving habits include:
said operator's operating characteristics.

6. The method of claim 5 wherein:
said operator's operating characteristics include:
speed, acceleration, braking, steering and cognitive factors.

7. The method of claim 1 further comprising:
said criteria specific to said operator's vehicle includes:
evaluating said vehicle age; and
evaluating said vehicle safety features; and
evaluating said vehicle's top speed;
evaluating said vehicle current value.

8. The method of claim 1 further comprising:
said criteria specific to the environment of said vehicle and operator includes:
evaluating the density of traffic in proximity of said vehicle; and
evaluating the density of traffic along a proposed route to be taken by said vehicle; and
evaluating the number of auto-operated vehicles in proximity of said vehicle; and
evaluating the number of human-operated vehicles in proximity of said vehicle; and
evaluating the average safety record of human-driven vehicles in said vehicle's proximity;
evaluating the time of day in which the dynamic temporal insurance premium is to be set; and
evaluating the weather during the duration in which the dynamic temporal insurance premium is to be set.

9. The method of claim 1 wherein:
said dynamic, temporal premium-pricing is dynamically recalculated on a recurring basis.

10. The method of claim 6 wherein:
said recurring basis is time-driven.

11. The method of claim 6 wherein:
said recurring basis is environment-driven.

12. The method of claim 6 wherein:
said recurring basis is driven by changes in said insurance risk score.

13. A method for dynamically setting a price for an insurance premium, the method comprising:
collecting driver and vehicle information through a mobile application including driver location, traffic density, number of auto-operated vehicles in proximity to said driver and vehicle, number of auto-operated vehicles along a proposed route, driver habits and driver safety record; and
encoding said driver and vehicle information; and
transmitting said encoded information to a server storing instructions; said instructions designed to perform:
scoring a risk factor according to said driver and vehicle information collected; and
determining an adjusted insurance premium based on said scoring; and
setting said adjusted insurance premium.

14. The method of claim 13 further comprising:
resetting said adjusted insurance premium upon each use of said vehicle.
